(19) United States
(12) Patent Application Publication
(10) Pub. No.: US 2017/0091800 A1
(43) Pub. Date: Mar. 30, 2017

(54) ELECTRONIC COUPON SYSTEM

(71) Applicant: Wal-Mart Stores, Inc., Bentonville, AR (US)

(72) Inventors: Anthony G. Wind, III, Gravette, AR (US); Bryan Douglas Finster, Centerton, AR (US)

(21) Appl. No.: 15/277,863

(22) Filed: Sep. 27, 2016

Related U.S. Application Data
(60) Provisional application No. 62/233,616, filed on Sep. 28, 2015.

(51) Int. Cl. G06Q 30/02; G06Q 20/38

(52) U.S. Cl. CPC G06Q 30/0224; G06Q 20/387; G06Q 30/0235

(57) ABSTRACT

A system monitors user purchases and determines a purchase schedule of the user for various products. User rules for substitutions of products and budget constraints are also received. Coupons are retrieved or received from various sources and associated with an account of the user. The purchase schedule is evaluated and items are automatically purchased with a frequency indicated by the purchase schedule. Coupons and product substitutions are made according to the user rules and budget constraints in order to provide savings to the user. Where coupons will expire prior to a scheduled purchase date for a product, the product will be purchased ahead of schedule subject to the budget constraints provided by the user.

### CROSS-REFERENCE TO RELATED APPLICATIONS

This application claims the benefit of U.S. Provisional Patent Application 62/233,616, filed Sep. 28, 2015, and titled “Electronic Coupon System”, the entire contents of which are hereby incorporated herein by reference.

### BACKGROUND

Field of the Invention

This invention relates to systems and methods for providing in-store demonstrations to customers.

Background of the Invention

Many retail customers attempt to reduce the cost of purchased goods by redeeming relevant coupons for the goods at the time of purchase. The management of the coupons themselves can be very time consuming, and the customer must also attempt to evaluate what coupon and purchased item combination provides the best value for them. This evaluation usually can involve multiple sizes of the product in question, and can further be compounded by multiple products that the customer may include in their evaluation.

Further compounding the activity is the recurring nature of the purchases, the necessity of identifying what needs to be purchased, budget constraints influencing the purchases, and the time and effort required by the consumer to perform the actual acquisition and transportation of the purchased goods from the retail establishment.

The systems and methods disclosed herein provide an improved approach for providing coupons to customers.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a schematic block diagram of a network environment suitable for implementing embodiments of the invention;

FIG. 2 is a schematic block diagram of an example computing device suitable for implementing methods in accordance with embodiments of the invention;

FIG. 3 is a process flow diagram of a method for gathering coupons for a user in accordance with an embodiment of the invention; and

FIG. 4 is a process flow diagram of a method for performing automated purchasers using coupons in accordance with an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Embodiments in accordance with the present invention may be embodied as an apparatus, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “module” or “system.” Furthermore, the present invention may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. In selected embodiments, a computer-readable medium may comprise any non-transitory medium that can contain, store, communicate, propagate, or transport the program for use by or in connection with the instruction execution system, apparatus, or device.

Computer program code for carrying out operations of the present invention may be written in any combination of one or more programming languages, including an object-oriented programming language such as Java, Smalltalk, C++, or the like and conventional procedural programming languages, such as the “C” programming language or similar programming languages. The program code may execute entirely on a computer system as a stand-alone software package, on a stand-alone hardware unit, partly on a remote computer spaced some distance from the computer, or entirely on a remote computer or server. In the latter scenario, the remote computer may be connected to the computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a non-transitory computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

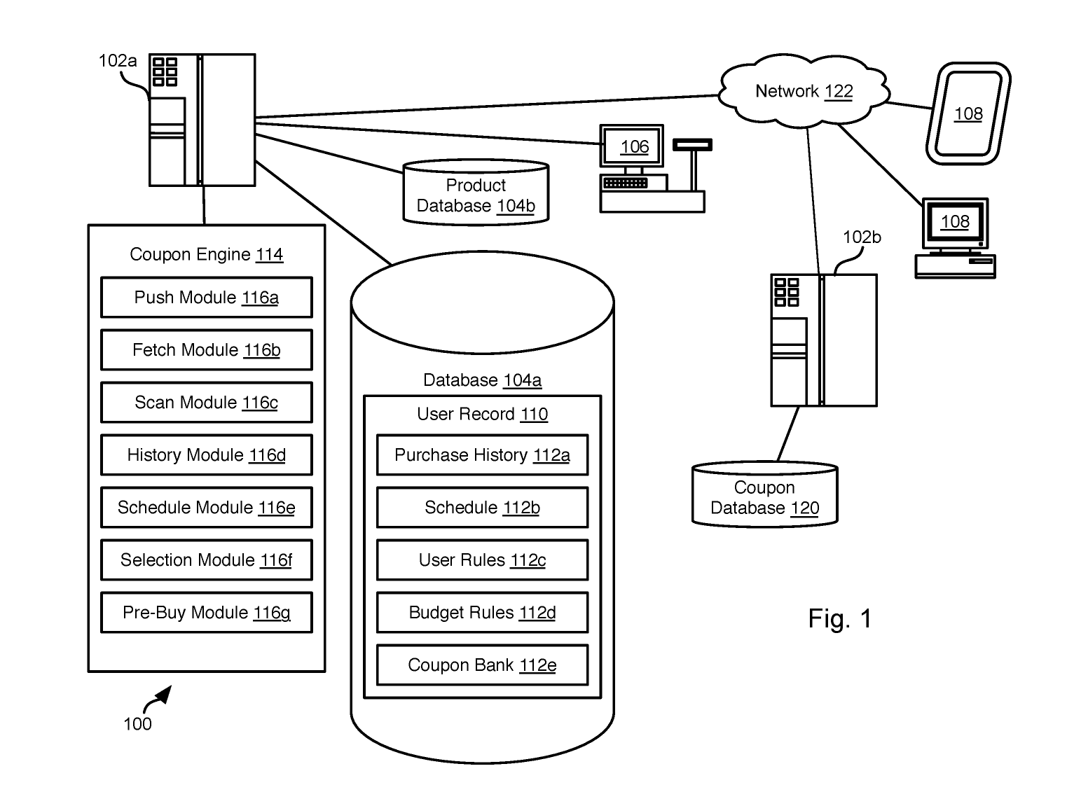

Referring to FIG. 1, a network environment 100 may be used to implement methods as described herein. The environment 100 may include a server system 102a associated with a corporate parent or controlling entity having one or more retail establishments associated therewith. The server system 102a may host or access a database 104a of user data. The server system 102a may further host or access a product database 104b. The product database may include for each product of a plurality of product records a product record including a product identifier and some or all of a unit cost, traits (e.g. keywords or other attribute descriptors), amount (weight, volume, number of units, etc.), or other information for a product.

The retail establishments may house point of sale devices (POS) 106 on which transactions may be concluded. The POS 106 may also be part of an e-commerce system. The e-commerce system may include, for example, a web-application that permits customers to purchase various products and/or services over the Internet. POSs 106 in communication with the server system 102a may include POSs 106 associated with a warehouse store that is a separate entity or format than the retail establishments.

Online POSs 106 may interact with remote user computers 108. In particular, server system 102a may host a website that may be browsed by users on the user computers 108 and through which the users may invoke purchase and shipment of products in a product database 104b. The remote user computers 108 may be embodied as laptop or desktop computers, mobile phones, tablet computers, wearable computers, or other computing device.

Records of transactions may be transmitted to the server system 102a by the POSs 106 at one or more outlets, e.g. retail establishments, warehouse stores, and ecommerce systems. The records of various transactions from the various outlets may be associated to individual customers. Specifically, unique data such as a credit card number, address, username, membership number, and the like may be associated with a particular customer. Accordingly, transaction records including one or more items of this unique data may be associated with that user. For example, transaction records determined to be associated with a particular user may be stored in a user record 110 for that user in the database 104a, such as in a purchase history 112a of the user record 110.

The user record 110 for that user may further include records of other information received from a user or gathered from observation of user actions. For example, the user record 110, may include a schedule 112b. The schedule 112b may be a purchase schedule.

The user record 110 may include user rules 112c. The user rules may specify rules for product substitution rules. For example, where a product is purchased repeatedly by the user, a substitution rule may specify whether substitution of a product of the same type (e.g. a different brand of the same product) may be substituted for that product. A user rule may be specified for a specific product (e.g. substitution permitted for HEINZ ketchup), type of product (ketchup), or category of products (condiments, toiletries, baked goods, etc.). A user rule may be keyword based, i.e. specified for products corresponding to a keyword (e.g. “ketchup”). The user rule may specify some or all of that fact that substitutions are permitted for the product, type of product, or category of products a specification of a number of brands that are permitted for substitution, or some other criteria that a substitute product must satisfy.

The user record 110 may further include budget rules 112d. A budget rule 112d may specify how much money to spend within a specified time period, e.g. X dollars per week, month, or some other period. A budget rule 112d may specify how much money to spend on a particular category (toiletries, food, clothes, etc.) within a specified time period.

The user record may include a coupon bank 112e. The coupon bank 112e may include coupons retrieved for the user or identified as relevant to the user. The coupons may include electronic coupons, images of paper coupons, offer codes, or other data specifying discounts for a product or brand of products.

The server system 102a may include a coupon engine 114 that both identifies coupons and redeems then on behalf of a user using the information in the user record 110 of the user.

The coupon engine 114 may include a push module 116a and a fetch module 116b. The push module 116a may receive coupons from a server system 102b of a vendor that are pushed from the server system 102b to the server system 102a, i.e. sent without first receiving a request from the server system 102a. For example, the server system 102b may host or access a coupon database 120 from which coupons are retrieved and sent to the server system 102a. Coupons obtained for the user by the push module 116a may be stored in the coupon bank 112e of the user record 110. The push module 116a may interface within API (application programming interface) provided by the entity owning or controlling the server system 102a to facilitate the pushing of coupons by vendors.

In some embodiments, the server system may aggregate, for at least a portion of a plurality of customers, purchases of the plurality of customers to obtain an aggregated purchase history. For example, the purchase histories 112a of a plurality of users, such as those belonging to a common demographic group, may be aggregated and characterized, such as by the most frequently purchased items in the aggregated purchase history. The aggregated purchase history or data obtained therefrom may be transmitted to a vendor, such as to a server system 102b. The vendor 102b may then use this information to select or define a coupon to be pushed to the server system 102a. A coupon selected or defined in the manner may then be received from the vendor computer system, such as in the from of an electronic coupon for a product in the aggregated purchase history.

The fetch module 116b that retrieves electronic coupons from a server system 102b. For example, using user rules 112c and/or the purchase history 112a, products of interest to the user may be identified because they satisfy a rule 112c or were previously purchased. Coupons for the products of interest may then be retrieved from a server system 102b of a vendor. For example, the fetch module 116b may automatically crawl websites accessible through the server system 102b and identify coupons for the products of interest. The fetch module 116b may identify coupons as responses to queries submitted to the server system 102b, the queries including keywords or traits from product records of products purchased by one or more users. Coupons obtained for the user by the fetch module 116b may be stored in the coupon bank 112e of the user record 110.

The coupon engine 114 may include a scan module 116c. The scan module 116c may receive images of coupons from a user device 108 associated with the user record 110, such as by the user record logging in to an account associated with the user record 110 on the user device 108. The scan module 116c may simply receive the images and store them in the coupon bank 112e or process them to extract product information. For example, the scan module 116c may identify an electronic coupon corresponding to the scanned coupon and store the electronic coupon in the coupon bank 112e of the user.

The coupon engine 114 may include a history module 116d and a schedule module 116e. The history module 116d evaluates the purchase history 112a of the user to identify products that have been purchased repeatedly. The schedule module 116e evaluates the purchases of the user and determines a purchasing schedule for each product or type of product and stores this in the schedule 112b of the user. For example, the purchase history 112a may be analyzed to identify products that are purchased repeatedly. In particular, a particular product type may be identified, i.e. ketchup, such that the dates and amounts on which that type of product was purchased by the user may be determined. A frequency with which that class of products may then be determined. In particular, where the product is defined by a unit of measure (volume, weight, units) then the frequency may be determined as units of measure per unit time (e.g., ounces per week, kilograms per month, etc.). This process may be repeated for each type of product purchased by a user repeatedly (e.g. purchased at least two times, three times, or other number of times).

The coupon engine 114 may include a selection module 116f. The selection module 116f evaluates the product database 104b, schedule 112b, user rules 112c, and coupon bank 112e and identifies products that provide the best value (e.g. cost per unit of measurement) and that satisfy the user rules. For example, the selection module determines according to schedule 112b that the user is likely in need of a product based on the purchase frequency for that product. For example, the schedule 112b may indicate that the user purchases at least 12 ounces of HEINZ ketchup once every three months. Accordingly, if X−(12 oz./3 months)*T is greater than zero, where X is the number of ounces of ketchup last purchased and T is the time (in months in this example) since the last purchase of ketchup, then the selection module 116f may invoke purchasing of ketchup. The brand and size of the bottle of ketchup may be determined according to the user rules 112c. If a coupon for a different brand is available or a lower price for a different brand is listed in the product data base 104b, then that other brand may be purchased if the user rules 112c permit such a substitution as outlined above in the description of the schedule 112b. Substitute products may be identified using keywords and traits in the product record of a product purchased by the user, i.e. substitute products may share traits and keywords of products actually purchased by the user.

The selection module 116f may invoke automated purchase of selected items. The purchase may be invoked without any user intervention or may be invoked following seeking and receiving confirmation that the user approves the purchase, such as by sending a prompt to the user computing device 108 of the user and receiving a confirmation instruction from the user computing device 108.

The coupon engine 114 may include a pre-buy module 116g. In some instances a coupon in the coupon bank 112e may be about to expire without being redeemed. However, a product for which the coupon offers a discount is not scheduled to be purchased until after the expiration date of the coupon as specified by the schedule 112b. Accordingly, the pre-buy module 116g may evaluate coupons that are about to expire and purchase items discounted by the coupons subject to budget rules 112d of the user. The manner in which this is performed is described in greater detail below with respect to FIG. 4.

The server systems 102a may be in data communication with the server system 102b, POSs 106, and user computers 108 by means of a network 122. The network 122 may include any wired or wireless connections and may include some or all of a local area network (LAN), wide area network (WAN), the Internet, or other type of network.

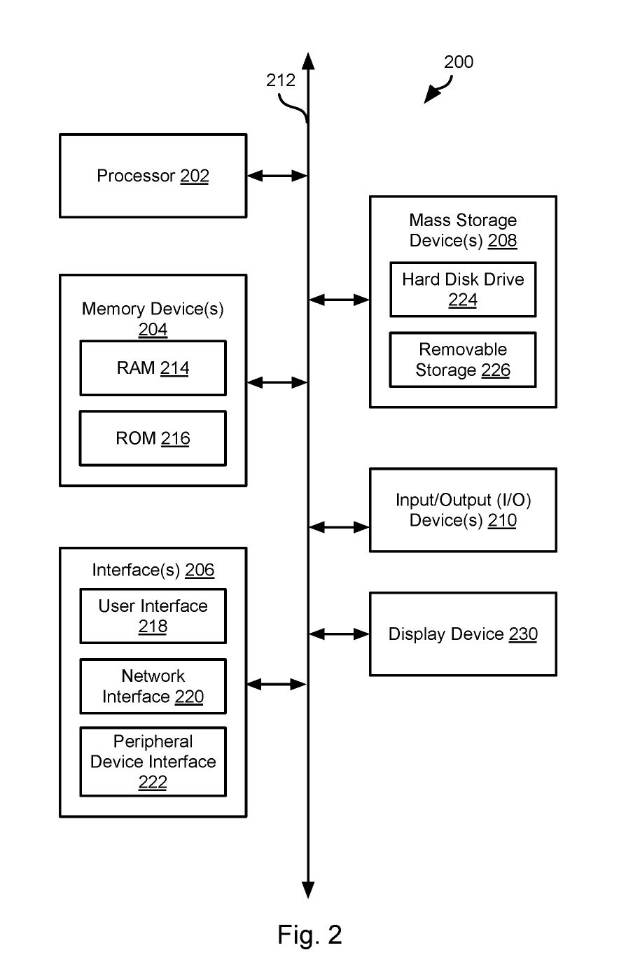

FIG. 2 is a block diagram illustrating an example computing device 200. Computing device 200 may be used to perform various procedures, such as those discussed herein. The server systems 102a, 102b, POSs 106, and user computers 108 may have some or all of the attributes of the computing device 200. Computing device 200 can function as a server, a client, or any other computing entity. Computing device can perform various monitoring functions as discussed herein, and can execute one or more application programs, such as the application programs described herein. Computing device 200 can be any of a wide variety of computing devices, such as a desktop computer, a notebook computer, a server computer, a handheld computer, a tablet computer and the like. A server system 102a may include one or more computing devices 200 each including one or more processors.

Computing device 200 includes one or more processor(s) 202, one or more memory device(s) 204, one or more interface(s) 206, one or more mass storage device(s) 208, one or more Input/Output (I/O) device(s) 210, and a display device 230 all of which are coupled to a bus 212. Processor(s) 202 include one or more processors or controllers that execute instructions stored in memory device(s) 204 and/or mass storage device(s) 208. Processor(s) 202 may also include various types of computer-readable media, such as cache memory.

Memory device(s) 204 include various computer-readable media, such as volatile memory (e.g., random access memory (RAM) 214) and/or nonvolatile memory (e.g., read-only memory (ROM) 216). Memory device(s) 204 may also include rewritable ROM, such as Flash memory.

Mass storage device(s) 208 include various computer readable media, such as magnetic tapes, magnetic disks, optical disks, solid-state memory (e.g., Flash memory), and so forth. As shown in FIG. 2, a particular mass storage device is a hard disk drive 224. Various drives may also be included in mass storage device(s) 208 to enable reading from and/or writing to the various computer readable media. Mass storage device(s) 208 include removable media 226 and/or non-removable media.

I/O device(s) 210 include various devices that allow data and/or other information to be input to or retrieved from computing device 200. Example I/O device(s) 210 include cursor control devices, keyboards, keypads, microphones, monitors or other display devices, speakers, printers, network interface cards, modems, lenses, CCDs or other image capture devices, and the like.

Display device 230 includes any type of device capable of displaying information to one or more users of computing device 200. Examples of display device 230 include a monitor, display terminal, video projection device, and the like.

Interface(s) 206 include various interfaces that allow computing device 200 to interact with other systems, devices, or computing environments. Example interface(s) 206 include any number of different network interfaces 220, such as interfaces to local area networks (LANs), wide area networks (WANs), wireless networks, and the Internet. Other interface(s) include user interface 218 and peripheral device interface 222. The interface(s) 206 may also include one or more peripheral interfaces such as interfaces for printers, pointing devices (mice, track pad, etc.), keyboards, and the like.

Bus 212 allows processor(s) 202, memory device(s) 204, interface(s) 206, mass storage device(s) 208, I/O device(s) 210, and display device 230 to communicate with one another, as well as other devices or components coupled to bus 212. Bus 212 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 200, and are executed by processor(s) 202. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

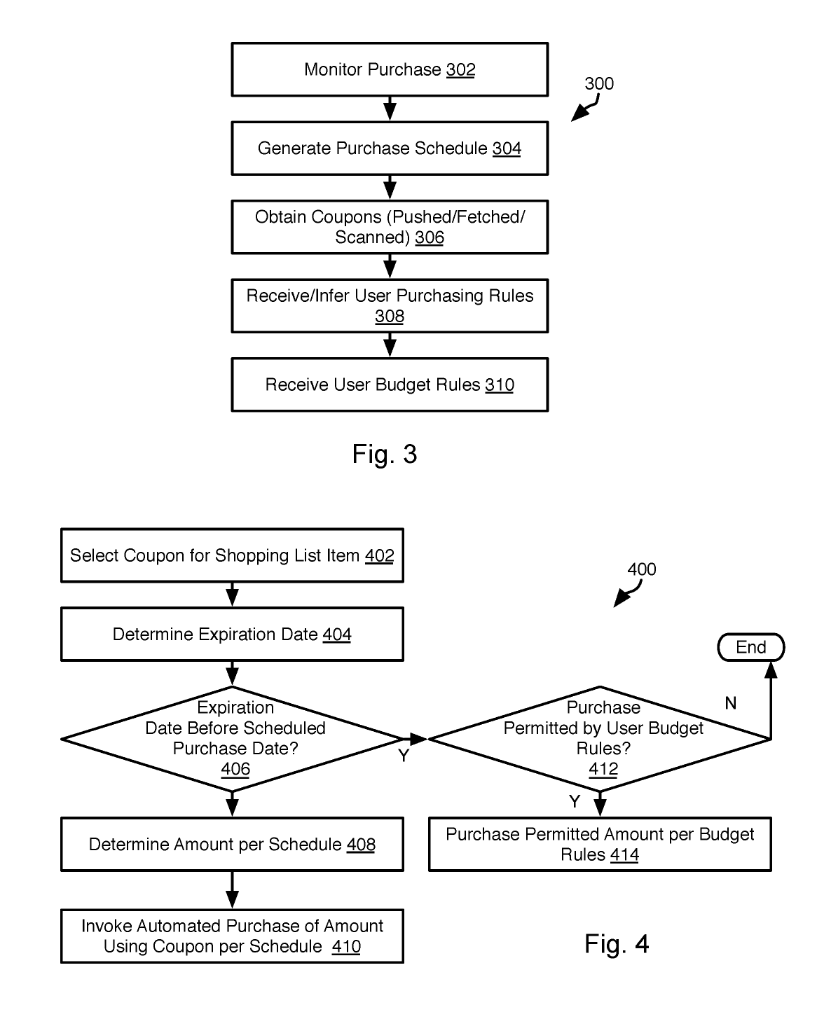

Turning now to FIG. 3, the illustrated method 300 may be executed by the server system 102a with respect to each user record 110 of a plurality of user records, the user record representing a specific customer, family, or other entity, hereinafter “the user.” Actions performed with respect to the user may be interpreted as being performed with respect to a user computing device 108 of the user. In particular, the method 300 may be executed by the coupon engine 114 described above.

The method 300 may include monitoring 302 purchases of the user. Monitoring 302 may include receiving records of transactions from one or more POSs 106 and storing records of, or references to, the transactions in the purchase history 112a of the user. Determining that the transaction was concluded by the user may be performed by determining that a credit card of the user was used or that a rewards account or username of the user was provided as part of the transaction.

The method 300 may include generating a purchase schedule 304. As noted above, this may include evaluating, by the schedule module 116e, the purchases of the user and determines a purchasing schedule for each product or type of product and stores this in the schedule 112b of the user. For example, the purchase history 112a may be analyzed to identify products that are purchased repeatedly. In particular, a particular product type may be identified, i.e. ketchup, such that the dates and amounts on which that type of product was purchased by the user may be determined. A frequency with which that class of products may then be determined. In particular, where the product is defined by a unit of measure (volume, weight, units) then the frequency may be determined as units of measure per unit time (e.g., ounces per week, kilograms per month, etc.). This process may be repeated for each type of product purchased by a user repeatedly (e.g. purchased at least two times, three times, or other number of times).

The method 300 may include obtaining 306 coupons for one or more products purchased by the user. The coupons may be received as pushed to the server system 102a by another server system 102b, as retrieved by the server system 102a from a vendor website or other electronic repository of electronic coupons, or received from the user by scanning or other input means. The coupons fetched by the server system 102a and stored in the coupon bank 112e of the user may be selected based on the purchase history and user rules 112c specified by the user. Specifically, coupons corresponding to a product purchased by the user or satisfying a user substitution rule may be searched out from vendor websites and/or databases and stored in the coupon bank 112e.

The method 300 may include receiving 308 or inferring user purchasing rules. Receiving user rules may include receiving user rules 112c as described above. Inferring user rules may include observing user behavior. For example, where a user purchases various brands of ketchup of various sizes to obtain a lowest price, then user rules 112c may be inferred that permits the substitution of various brands of ketchup rather than limiting purchases to a specific brand.

The method 300 may include receiving 310 user budget rules. A user budget rule may include a budget rule 112e as described above. The budget rule 112e specifies an amount of money that may be spent within a given time period (week, two weeks, month, quarter, etc.). The amount of money may be an amount available for automated purchases as described herein or may include the amount of money available to be spent in purchases by the user as well as automated purchases, i.e. the amount of money available for automated purchases may be a budget amount less purchases of the user during the budget period as indicated in the purchase history 112a or other records of expenditures provided by the user.

FIG. 4 illustrates a method 400 for performing automated purchasing using the information obtained form executing the method 300 of FIG. 3. The illustrated method 400 may be executed by the server system 102a with respect to each user record 110 of a plurality of user records, the user record representing a specific customer, family, or other entity, hereinafter “the user.” Actions performed with respect to the user may be interpreted as being performed with respect to a user computing device 108 of the user. In particular, the method 400 may be executed by the coupon engine 114 described above.

The method 400 may include selecting 402 a coupon corresponding to a shopping list item, i.e. an item that is in the purchase history 102a of the user or satisfies a user substitution rule 112c with respect to an item in the purchase history 102a of the user.

The expiration date of the coupon may be determined 404. If the expiration date is not found 406 to be before the expected purchase date of the item according to the schedule 112b, then the amount of the item to purchase may be determined 408 according to the schedule 112b and automated purchase of the item may be invoked 410 using the coupon in accordance with the schedule. For example, if the user purchases at least 12 ounces of ketchup every three months, the coupon may be redeemed to buy at least 12 ounces of ketchup when the last purchase of ketchup is inferred to be consumed based on the consumption rate of 12 oz./3 months (e.g. 4 oz. per month). The amount purchased may be based on the best value obtained either with or without coupon, i.e. the bottle size providing the best cost per ounce or the bottle size referenced by a coupon that provides the best cost per ounce. Invoking automated purchase at step 410 and elsewhere in this disclosure may include invoking automated electronic payment for the purchase and invoking shipment to the user at a fulfillment center or by sending a message to a vendor to perform shipment to the user. Shipment may be performed using a site-to-store method whereby a product is shipped to a store and made available for pickup. Shipment may be performed directly to an address specified by the user.

If the coupon is found 406 to have an expiration date prior to the scheduled purchase date for the item, then the method may include evaluating 412 whether a purchase of the item is permitted earlier then scheduled according to the budget rules 112d. For example, this may include determining whether unspent money in the budget for a budget period is available for the advanced purchase. In some embodiments, budget rules may specify rules applying to early purchases to take advantage of coupons that are expiring, i.e. a specific amount that may be spent per unit time (e.g. month) on advanced purchases. In either case, whether the purchase of at least one unit of the item may be determined at step 412, if so, then purchase of at least one unit, and possibly more, is then invoked at step 414. The number of units purchased may be the maximum permitted based on budget rules or may be limited to only one unit. The number of units purchased at step 414 may be determined based on shelf life, e.g. the maximum number that will be consumed based on the consumption rate of the schedule 112b prior to expiration of the shelf lift of the product and that also satisfies the budget rules.

The present invention may be embodied in other specific forms without departing from its spirit or essential characteristics. The described embodiments are to be considered in all respects only as illustrative, and not restrictive. The scope of the invention is, therefore, indicated by the appended claims, rather than by the foregoing description. All changes which come within the meaning and range of equivalency of the claims are to be embraced within their scope.

What is claimed is:

1. A system comprising:
a customer knowledge database storing a customer profile for each customer of a plurality of customers, the customer profile for the each customer including (a) a shopping list including a plurality of item entries, each item entry including one or more keywords identifying a class of product and a consumption schedule and (b) one or more budget rules specifying a spending schedule for the each customer as received from the each customer;
a server system comprising one or more processors and one or more memory devices operably coupled to the one or more processors, the one or more memory devices storing executable and operational code effective to execute a customer engine comprising—
a coupon module effective to, for each customer of the plurality of customers, obtain one or more electronic coupons from one or more network-connected computer systems, at least a portion of the one or more electronic coupons corresponding to the one or more keywords of the one or more entries of the shopping list of the each customer; and
a purchasing module effective to, for each customer of the plurality of customers—
evaluate expiration dates of the one or more electronic coupons corresponding to the keywords of the one or more entries of the shopping list of the each customer;
if (i) a coupon of the one or more electronic coupons has an expiration date prior to the consumption schedule for the item entry having keywords corresponding to the coupon and (ii) the one or more budget rules indicate allowability of purchase of at least one instance of a product discounted by the coupon, invoke automated purchase of the at least one instance of the product discounted by the coupon in advance of the consumption schedule for the item entry having keywords corresponding to the coupon;
if not (i) or not (ii), invoke automated purchase of a product corresponding to the keywords of the item entry of the each customer having keywords corresponding to the coupon according to the consumption schedule of the item entry.

2. The system of claim 1, wherein the consumption schedule of each item entry specifies a recurrence schedule and an amount for each item entry.

3. The system of claim 2, wherein the customer engine further comprises a monitoring module effective to receive notifications of purchases of each customer of the plurality of customers and storing records of the notifications in a purchase history of the each customer.

4. The system of claim 3, wherein the customer engine is further effective to, for each customer of the plurality of customers:
generate the item entries by generating each item entry according to attributes and purchase frequency of at least one item in a purchase history of the each customer.

5. The system of claim 1, wherein the coupon module if further effective to, for each customer of the plurality of customers, obtain the one or more electronic coupons from the one or more network-connected computer systems, by receiving the one or more electronic coupons in a push notifications from the one or more network-connected computer systems.

6. The system of claim 5, wherein the customer engine is further effective to:
aggregate, for at least a portion of the plurality of customers, purchases of the plurality of customers to obtain an aggregated purchase history;
transmit the aggregated purchase history to a vendor computer system;
receive, from the vendor computer system, an electronic coupon for a product in the aggregated purchase history.

7. The system of claim 1, wherein the coupon module is further effective to, for each customer of the plurality of customers, obtain the one or more electronic coupons from the one or more network-connected computer systems, by performing queries of one or more network-connected computer systems including the keywords of the plurality of item entries of the each customer.

8. The system of claim 1, wherein the coupon module is further effective to, for each customer of the plurality of customers, obtain the one or more electronic coupons from images of scanned coupons received from a user device of the each customer.

9. The system of claim 1, wherein the purchasing module is further effective to invoke automated purchase of the product corresponding to the keywords of the item entry of the each customer having the keywords corresponding to the coupon by:
identifying one or more product candidates corresponding to the keywords of the item entry;
identifying one or more candidate coupons for the one or more product candidates; and
identifying the product from the one or more product candidates according to purchase prices for the one or more product candidates and the one or more candidate coupons.

10. The system of claim 9, wherein:
the customer knowledge database further stores in the customer profile for each customer selection rules received from the each customer; and
the purchasing module is further effective to identify the one or more product candidates corresponding to the keywords of the item entry according to the customer selection rules.

11. A method comprising:
providing a customer knowledge database storing a customer profile for each customer of a plurality of customers, the customer profile for the each customer including (a) a shopping list including a plurality of item entries, each item entry including one or more keywords identifying a class of product and a consumption schedule and (b) one or more budget rules specifying a spending schedule for the each customer as received from the each customer;
performing, by a server comprising one or more processors and one or more memory devices operably coupled to the one or more processors, a method comprising—
obtaining one or more electronic coupons from one or more network-connected computer systems, at least a portion of the one or more electronic coupons corresponding to the one or more keywords of the one or more entries of the shopping list of the each customer;
for each customer of the plurality of customers—
evaluating expiration dates of the one or more electronic coupons corresponding to the keywords of the one or more entries of the shopping list of the each customer;
if (i) a coupon of the one or more electronic coupons has an expiration date prior to the consumption schedule for the item entry having keywords corresponding to the coupon and (ii) the one or more budget rules indicate allowability of purchase of at least one instance of a product discounted by the coupon, invoking automated purchase of the at least one instance of the product discounted by the coupon in advance of the consumption schedule for the item entry having keywords corresponding to the coupon; and
if not (i) or not (ii), invoking automated purchase of a product corresponding to the keywords of the item entry of the each customer having keywords corresponding to the coupon according to the consumption schedule of the item entry.

12. The method of claim 11, wherein the consumption schedule of each item entry specifies a recurrence schedule and an amount for each item entry.

13. The method of claim 12, further comprising receiving notifications of purchases of each customer of the plurality of customers and store records of the notifications in a purchase history of the each customer.

14. The method of claim 13, further comprising, for each customer of the plurality of customers:
generating the item entries by generating each item entry according to attributes and purchase frequency of at least one item in a purchase history of the each customer.

15. The method of claim 11, further comprising, for each customer of the plurality of customers, obtaining the one or more electronic coupons from the one or more network-connected computer systems, by receiving the one or more electronic coupons in a push notifications from the one or more network-connected computer systems.

16. The method of claim 11, further comprising, for each customer of the plurality of customers, obtaining the one or more electronic coupons from the one or more network-connected computer systems, by performing queries of one or more network-connected computer systems including the keywords of the plurality of item entries of the each customer.

17. The method of claim 11, further comprising, for each customer of the plurality of customers, obtaining the one or more electronic coupons from images of scanned coupons received from a user device of the each customer.

18. The method of claim 11, wherein invoking automated purchase of the product corresponding to the keywords of the item entry of the each customer having the keywords corresponding to the coupon further comprises:
identifying one or more product candidates corresponding to the keywords of the item entry;
identifying one or more candidate coupons for the one or more product candidates; and
identifying the product from the one or more product candidates according to purchase prices for the one or more product candidates and the one or more candidate coupons.

19. The method of claim 18, wherein:
the customer knowledge database further stores in the customer profile for each customer selection rules received from the each customer; and
wherein identifying the one or more product candidates corresponding to the keywords of the item entry is performed according to the customer selection rules.

20. The method of claim 11, wherein invoking automated purchase comprises invoking automated delivery to a residence of the each customer.
